(19) United States
(12) Patent Application Publication
(10) Pub. No.: US 2009/0271222 A1
(43) Pub. Date: Oct. 29, 2009

(54) Monthly Income Reversionary Annuity Insurance Policy

(76) Inventors: Robert A. Marks, Edmond, OK (US); Gerald W. McRae, Norman, OK (US); Charles Jorge, Edmond, OK (US); Tom E. Baumann, Norman, OK (US)

Correspondence Address: DUNLAP CODDING, P.C., PO BOX 16370, OKLAHOMA CITY, OK, 73113, US

(21) Appl. No.: 12/109,126

(22) Filed: Apr. 24, 2008

(51) Int. Cl. G06Q 40/00

(52) U.S. Cl. 705/4

(57) ABSTRACT

A life insurance product provided with one or more mediums and indicia recorded on the one or more mediums identifying an insured, an irrevocable beneficiary, a fixed term ending upon a predetermined age of the insured for the life insurance product, a payment schedule for premiums, a determined death benefit payable to the beneficiary upon death of the insured, with the death benefits defined as a guaranteed stream of payments to be paid for the life of the irrevocable beneficiary. The life insurance product also includes means for executing the one or mediums to form a life insurance contract.

### CROSS-REFERENCE TO RELATED APPLICATIONS

Not Applicable.

### STATEMENT REGARDING FEDERALLY SPONSORED RESEARCH AND DEVELOPMENT

Not Applicable.

### THE NAMES OF THE PARTIES TO A JOINT RESEARCH AGREEMENT

Not Applicable.

### Reference to a “Sequence Listing,” a Table, or a Computer Program Listing Appendix Submitted on a Compact Disc and an Incorporation-by-Reference of the Material on the Compact Disc (See § 1.52(E)(5)). The Total Number of Compact Discs Including Duplicates and the Files on Each Compact Disc Shall be Specified

Not Applicable.

### BACKGROUND OF THE INVENTION

Life and health insurance companies market a variety of insurance and investment-type products. A life insurance policy is a policy under which the insurance company promises to pay a benefit upon the death of the person who is insured. Life insurance is provided on both an individual and a group basis and is available under a variety of types of policies. Three main types of life insurance policies are: term life insurance, permanent life insurance and endowment insurance.

Term life insurance provides a death benefit if the insured dies during a specified period.

Permanent life insurance provides life insurance coverage throughout the insured's lifetime and also provides a savings element. As premiums are paid for these policies an accumulated savings amount—known as the policy's cash value—gradually builds. A policy's cash value can be a valuable asset that the policyowner can use in a number of ways.

Endowment insurance provides a policy benefit that is paid either when the insured dies or on a stated date if the insured lives until then. Endowment insurance has some characteristics of both term life insurance and permanent life insurance. Like term insurance, endowment insurance provides life insurance coverage for only a stated period of time. And like permanent life insurance, endowment insurance provides a savings element.

In all cases, the policy benefit is paid only if the policy is in force when a covered loss occurs. A policy remains in force and thus provides the specified insurance coverage as long as the required premiums are paid when due. In addition to providing life insurance coverages, life insurance companies market various products that are designed to provide consumers with a way to provide themselves with periodic income benefits, especially retirement income benefits. An annuity is a series of periodic payments. For example, when the insured of a life insurance policy dies, a relatively large sum of money is often payable. Life insurance policy proceeds can be paid in the form of an annuity, over a period of time, rather than in a lump sum. An annuity can also be a contract under which an insurance company promises to make a series of periodic payments to a named individual in exchange for a premium or a series of premiums.

### BRIEF DESCRIPTION OF THE SEVERAL VIEWS OF THE DRAWING

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of an exemplary method utilized in accordance with the present invention for administering an insurance program.

FIG. 2a-2j cooperate to illustrate an exemplary insurance product generated in accordance with the present invention. More particularly,

FIG. 2a is an exemplary reversionary annuity insurance disclosure notice.

FIG. 2b is an exemplary policy schedule.

FIG. 2c is an exemplary table of maximum premiums.

FIG. 2d is an exemplary continuation of coverage benefit.

FIG. 2e-2g cooperate to illustrate an exemplary summary of policy proceeds.

FIG. 2h illustrates a receipt of hand delivery form.

FIG. 2i illustrates an exemplary “Premium Protection” rider.

FIG. 2j illustrates an exemplary “Extension of Monthly Benefit” rider.

### DETAILED DESCRIPTION OF THE INVENTION

Presently preferred embodiments of the invention are shown in the above-identified figures and described in detail below. In describing the preferred embodiments, like or identical reference numerals are used to identify common or similar elements. The figures are not necessarily to scale and certain features and certain views of the figures may be shown exaggerated in scale or in schematic in the interest of clarity and conciseness.

The presently disclosed and claimed invention is directed to a method for administering an insurance program and the insurance products generated and executed thereof to provide benefits to beneficiaries who survive respective insureds. The insurance program can be implemented and/or administered in a variety of manners such as manually or with the aid of one or more computer systems. Four examples of insurance products generated in accordance with the insurance program will be discussed below.

### Version A

In one embodiment, the insurance program provides an insurance product including a term life reversionary annuity that pays an annuity during a payment term for the amount of benefit selected at issue to a designated beneficiary beginning a predetermined period, such as one month, following the death of the insured, provided death of the insured occurs prior to a predetermined coverage period ending date. In one aspect, the predetermined coverage period is a number of years such as, for example 10, 15, or 30 years or the like. In this example, the coverage period ending date would be the policy anniversary occurring 10 (15 or 30) years after issuance. In another aspect, the coverage period terminates when the insured reaches a terminal age, such as, for example the age of 67. Alternatively, the insurance product can be a permanent life insurance policy.

In a preferred embodiment, the payment term annuity terminates at the earlier of (1) the predetermined coverage period ending date or (2) the date of death of the beneficiary. Once benefits have initiated, the policy can also include a period certain term such that death benefits will be paid for a minimum amount of time, such as, for example three years.

The premium for this product can be determined at the time of sale of the insurance product but may be subject to change in response to changes in the actuarial data and risk factors. However, the premium is preferably guaranteed at the time of sale of the product not to exceed a maximum premium. In another aspect, the premium can be subject to a premium guarantee period for a certain time, during which the premium will not increase. Thus, for the number of year(s) as specified in a contract for the insurance product, the premium may be increased or decreased after the premium guarantee period, but never to exceed a maximum premium schedule shown in the policy. Alternatively, the premium could be guaranteed for the entire premium paying period. The premium paying period can be the entire coverage period or any time less than the entire coverage period.

The death benefit is determined and guaranteed at the time of sale of the product and further defines a guaranteed stream of payments to the beneficiary beginning following the death of the insured.

The product may include a variety of options or riders. For example, the insurance product can be provided with a rider for the owner to select the benefit payments to be increased to simulate increases in the cost of living, such as 3% compounded annually, beginning a predetermined time period, such as 13 months following the date of the first payment.

Other optional riders include a “waiver of premium” and a “premium protection rider.” The waiver of premium rider waives the premium if the insured becomes totally disabled, as defined in the rider, for a predefined period of time, such as at least six months, also as defined in the rider. Premiums are waived for the policy and any riders after the insured becomes totally disabled and for the duration of such disability, as defined in the rider.

The premium protection rider provides a death benefit to the insured in the event the beneficiary predeceases the insured during the coverage period. The surviving insured preferably is provided with a choice of death benefit options, which can be made at the time of claim. The death benefit options can vary. For example, one death benefit can be a lump sum payment of, e.g., 50% of all premiums paid, or another death benefit can be 100% of all premiums paid in a number of installments as a temporary life annuity to the insured. For example, the death benefit can be paid as 10 equal (or different) installments to the insured or the insured's designee. If the latter is selected, full refund of premium may be dependent upon one or more additional factors, such as the survivorship of the insured for an entire installment period.

In one aspect, the beneficiary of the death benefits is selected at the time of issuance of the insurance product and is irrevocable. As such, should the beneficiary predecease the insured, the insurance product shall terminate. In another aspect, a rider can be selected which provides the insured an ability to select a new beneficiary upon the occurrence of certain predetermined conditions. For example, upon selection of this rider, the insured can select a new beneficiary upon presentation of a new marriage license, death decree for the original beneficiary or the like. Without selection of this rider, the beneficiary chosen at the time of issuance would be irrevocable.

Thus, in one embodiment—Version A includes a term reversionary annuity that pays an annuity during the payment term for a predetermined amount to a designated beneficiary beginning, for example one month following the death of the insured. The beneficiary is preferably named at the point of sale and the death benefits are also determined at the point of sale. The premiums are determined at the point of sale, but may be subject to change up to a maximum premium. The premium defined at the point of sale may be equal to the maximum premium. Assuming that all premiums are paid, then benefits will be paid to the beneficiary provided that death of the insured occurs before the predetermined terminal age or the fixed coverage term, as stated in the policy, and the designated beneficiary is living at the time of the insured's death.

### Version B

In this version, the insurance product is identical to the Version A discussed above, except that the insurance product includes a first insured and a second insured, and a first beneficiary and a second beneficiary. In this version, the first beneficiary would receive a first stream of death benefits upon death of the first insured and the second beneficiary would receive a second stream of death benefits upon the death of the second insured. In one exemplary embodiment of this version, the first insured also serves as the second beneficiary and the second insured serves as the first beneficiary. With version B, only one stream of death benefits is payable under the insurance product. So, the first or second beneficiary would receive the stream of death benefit upon death of the first or second insured.

In one example of this version, the insurance product could be purchased by a husband and a wife. In this example, the husband would be the first insured and the second beneficiary and the wife would be the first beneficiary and the second insured. Thus, in this example, if the husband (first insured) predeceased the wife (first beneficiary), the wife would receive the first stream of death benefits and similarly, if the wife (second insured) predeceased the husband (second beneficiary), the husband would receive the second stream of death benefit.

Another aspect of this version is that the first death benefit does not have to be the same as the second death benefit. For example, if the wife, from the previous example, was the primary wage earner, the second death benefit could be substantially more than the first death benefit so as to replace the primary wages of the wife upon her death. Alternatively, the second death benefit could be less than the first death benefit if the husband was the primary wage earner. The first and second death benefits are independently adjusted to cover the financial needs of the first and second insured should either predecease the other. The first and second death benefits would be selected at the time of issuance of the insurance product.

The above example is provided for ease of understanding but should not be read to limit the scope of this version in any manner. As is understood in the art, the first and second insured and first and second beneficiary could have other relational connections, such as, for example brother-sister, aunt-niece, uncle-niece, grandparent-grandchild, parent-child or the like. Also, it is not necessary for the first and second insured to be related and thus could have other connections, such as, for example, business associations or the like. Similar to Version A, the premium for this product can be determined at the time of sale of the insurance product but can be, but not necessarily, subject to change in response to changes in factors, such as an in force book of business. However, the premium is preferably guaranteed at the time of sale of the product not to exceed a maximum premium (which could be the same as the initial premium). In another aspect, the premium can be subject to a premium guarantee period for a certain time, during which the premium will not increase. The death benefit is determined and guaranteed at the time of sale of the product. Thus, for the number of year(s) as specified in a contract for the insurance product, the premium may be increased or decreased after the premium guarantee period, but never to exceed a maximum premium schedule shown in the policy.

Cost of living adjustments as well as the optional riders discussed above for Version A are also available for Version B. In addition, an extension of benefits rider is also available. Once benefits have commenced, the extension of benefits rider extends benefits for a certain time period, such as three years after the death of the beneficiary; however, this rider will preferably not provide benefits beyond the predetermined coverage period.

One exemplary use for Version A or B is directed to the mortgage market for real property, such as residential or commercial property. In this instance, Versions A and B permit people to maintain mortgage payments following the unexpected death of the insured. In this example, the predetermined coverage period would preferably correspond to the term, or the remaining term of the mortgage, ie., 10, 15 or 30 years, and each payment of the death benefit would preferably be sufficient to cover the amount of the mortgage payment so that the beneficiary would not lose or otherwise have to sell the real property in view of the unexpected death of the insured. By providing a guaranteed period once benefits are initiated, the beneficiaries' family or heirs are also protected by providing them with time to sell the real property, if they should chose to do so.

### Version C

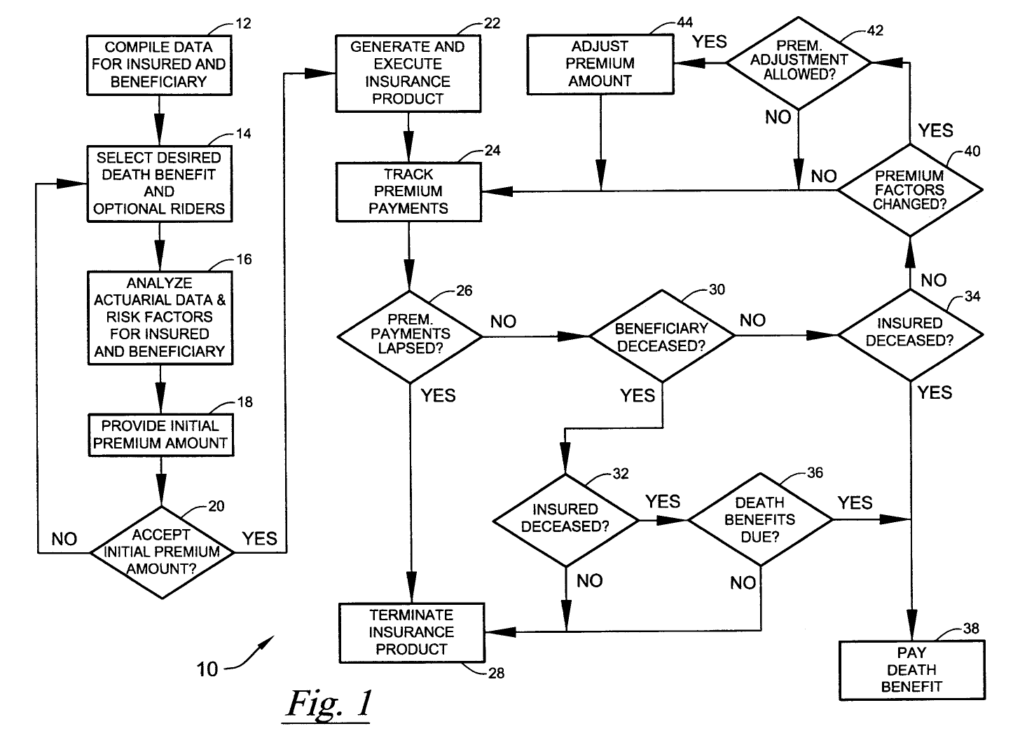

Referring now to FIG. 1, shown therein is a block diagram of a method 10 for administering an insurance program in accordance with the present invention. In accordance with the method 10, data is compiled for based upon the type of insurance product e.g., versions a-d discussed above, to be issued. For example, data identifying one or more insured, one or more owner and one or more beneficiary is compiled as indicated by a block 12. The data typically includes identification of the name, and address of the insured(s), the beneficiary(ies) and the owner(s). The data also typically includes risk factor information for the beneficiary and the owner so that a suitable premium can be calculated for a particular type of life insurance, e.g., term or permanent, particular death benefit(s) and optional riders. The risk factor information can include age, gender, smoking status, and health information. In a preferred embodiment, the beneficiary's age and gender, as well as the insured's age and gender, are used to determine the initial premium; however, there preferably is no health underwriting for the beneficiary. That is, the insurance company preferably does not base the rate on the health condition of the beneficiary, although the health condition of the beneficiary could be used as a factor to determine the rate. In this example, the insurance company determines the health of the insured(s) which provides one factor in determining the premium.

Then, a desired health benefit(s) and optional riders are selected as indicated by a block 14. The death benefit(s) is typically a payment for a predetermined period during the life of the beneficiary, but could be for the remaining life of the beneficiary. The death benefit can be defined as a monthly payment or other frequency of payment. A variety of riders can also be selected as discussed above.

Once the death benefit(s) and the optional riders are selected, the method branches to a block 16 where actuarial data and risk factors are analyzed for the insured(s) and the beneficiary(ies) to calculate an initial premium amount as well as a maximum premium amount. The initial premium amount can be the same as the maximum premium amount.

Actuaries can be used to calculate predetermined premiums based on a variety of risk factors and the predetermined premiums are stored in one or more database or spreadsheet which can be accessed by an agent to determine the initial premium amount as well as the maximum premium amount. In a preferred embodiment, the amount of insurance can be calculated by inputting the following, but not limited to, information including into a computer system:

Insured Age

Gender

Beneficiary Age

Monthly Premium Requested or Monthly Benefit Requested

Smoking Status

Risk Class

Premium paying period

Optional Riders

Once the above information is input, software running on the computer system calculates the premium and benefit as well as a present value of the benefits.

The initial premium amount as well as the maximum premium amount are provided to the prospective owner, the insured(s) and/or the beneficiary(ies) as indicated by a block 18, who then decide whether or not to accept the initial and maximum premium amount as indicated by the block 20. If not, then the method branches back to the step 14 for repeating steps 14, 16, 18 and 20 until a suitable initial premium and maximum premium is accepted.

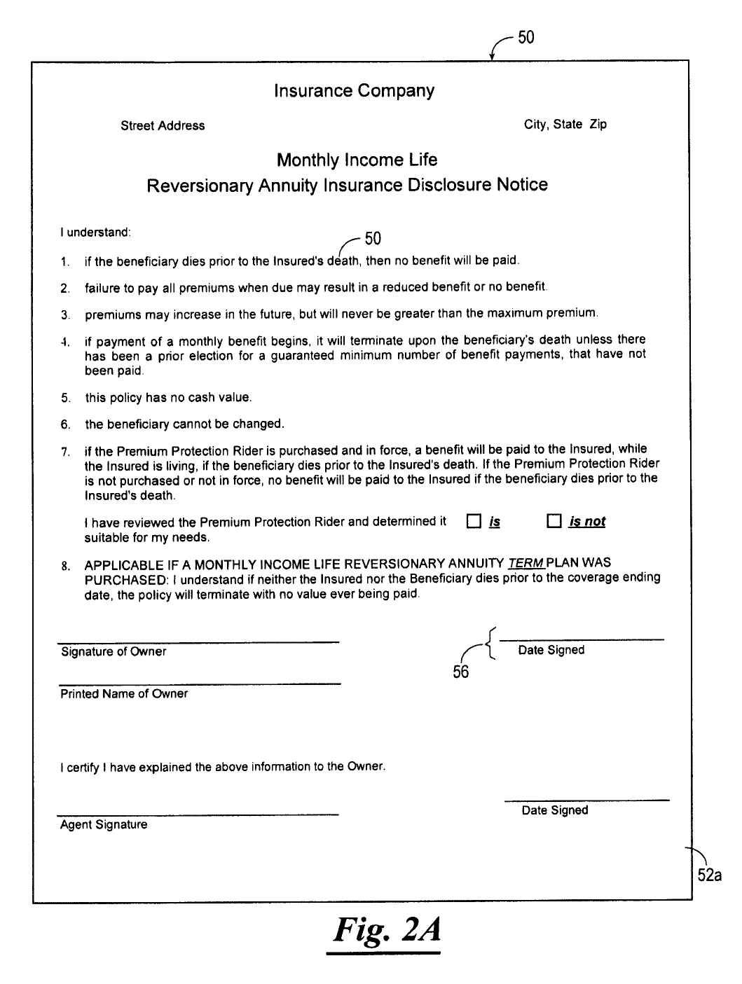

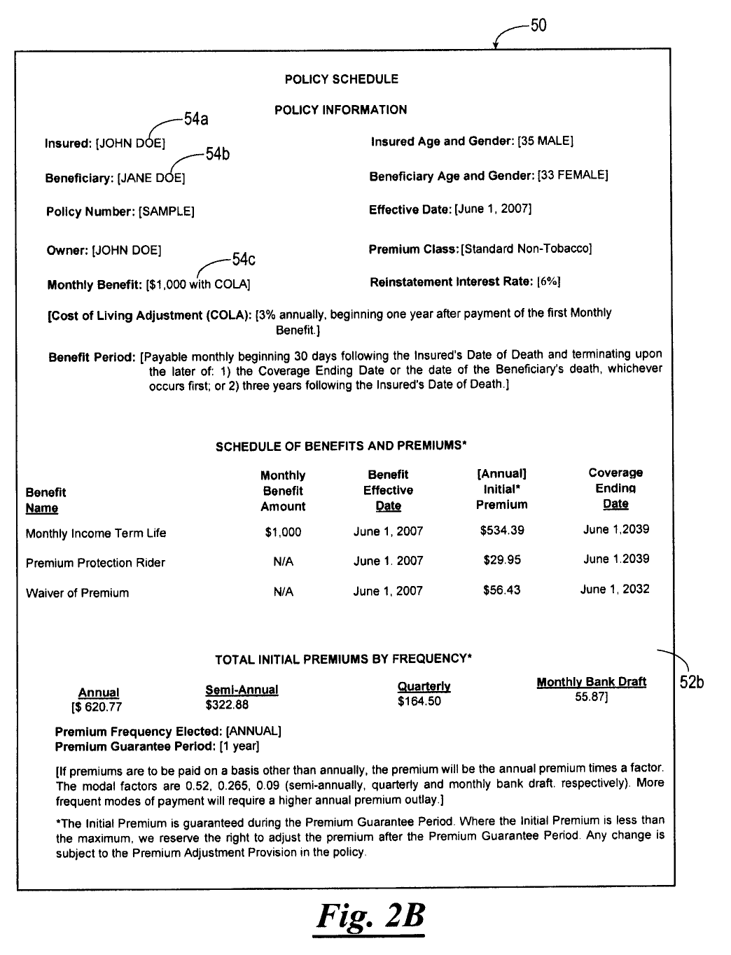

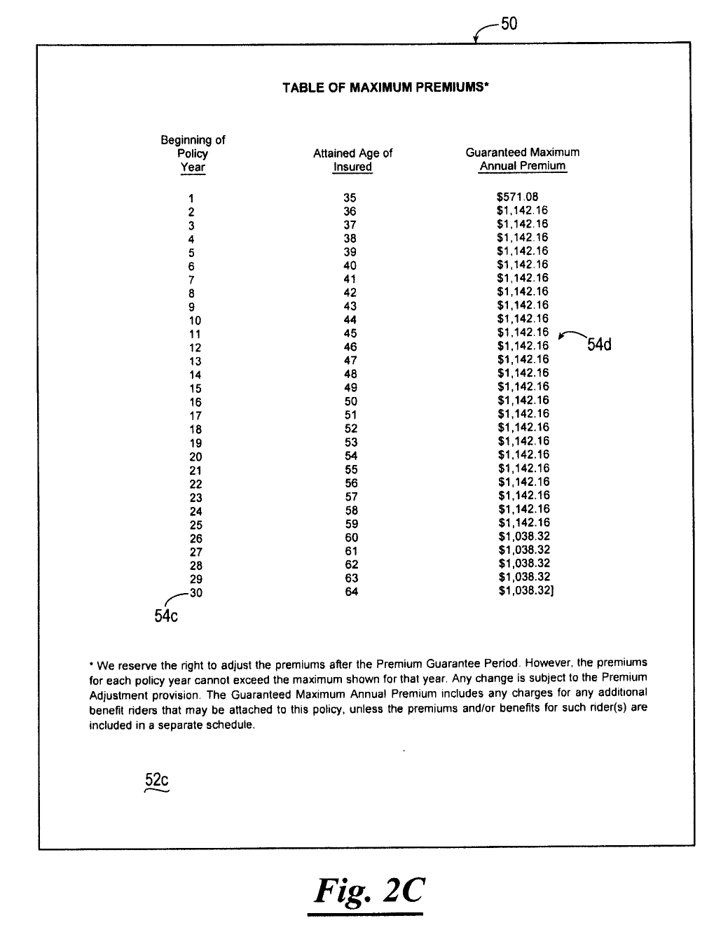

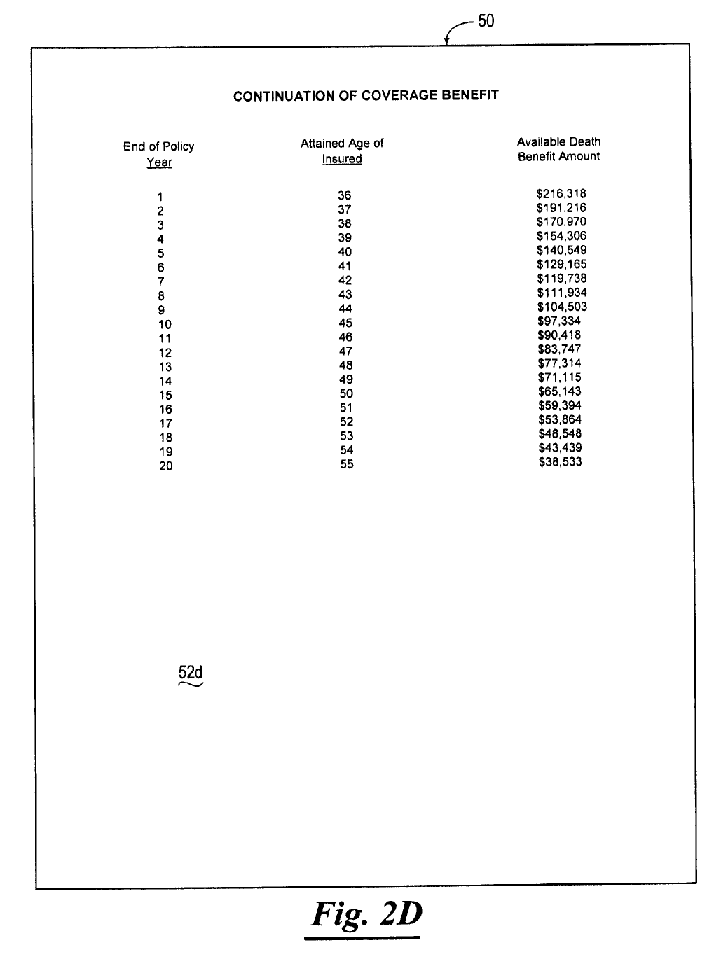

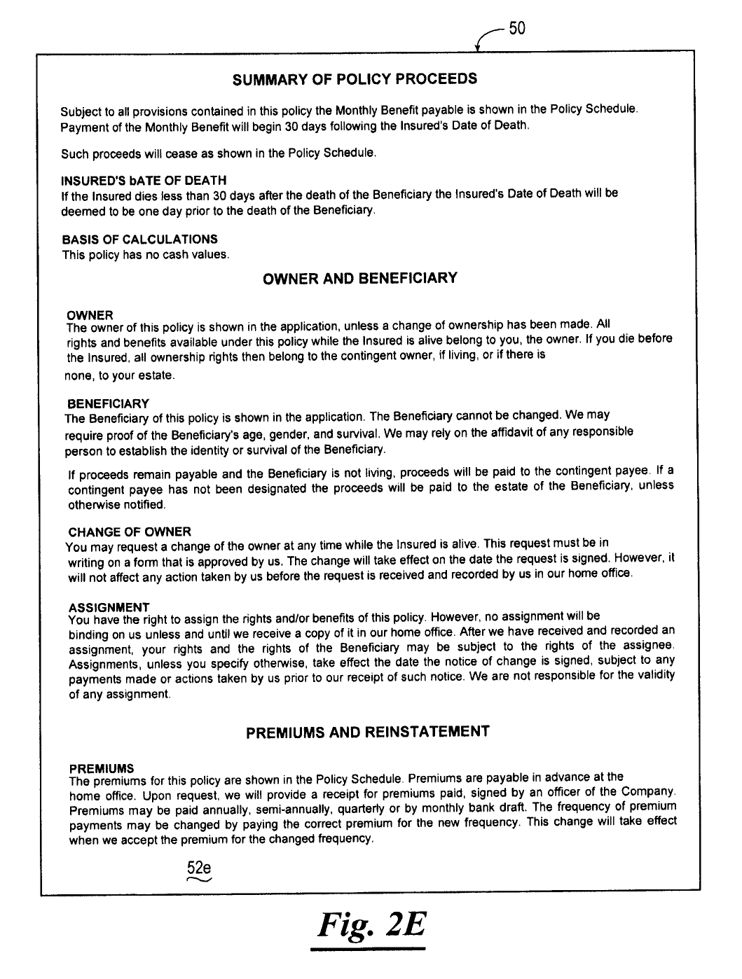

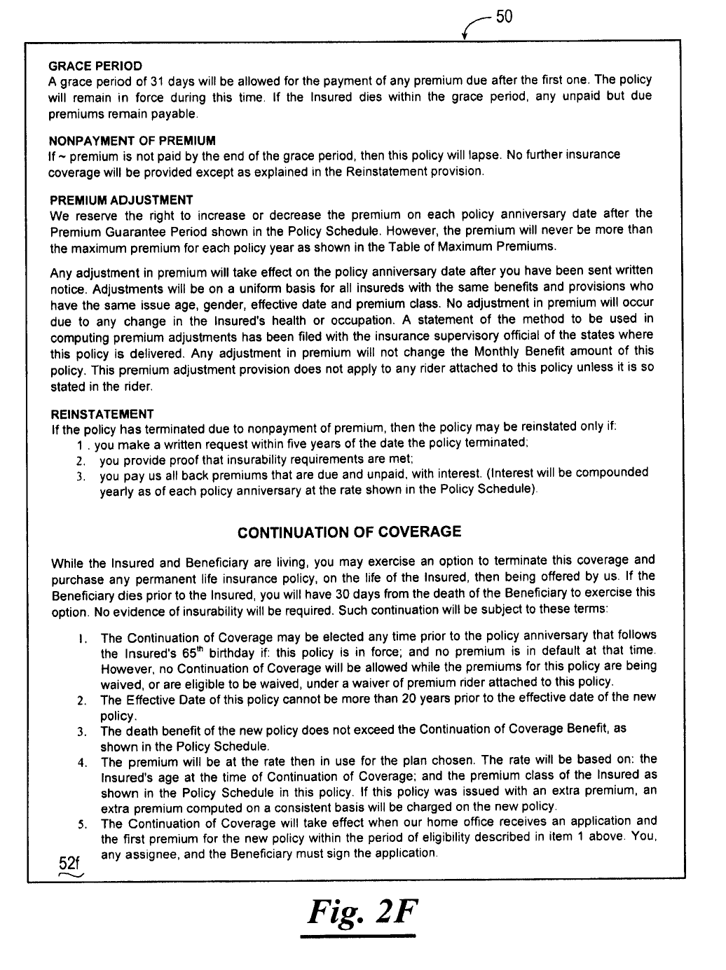

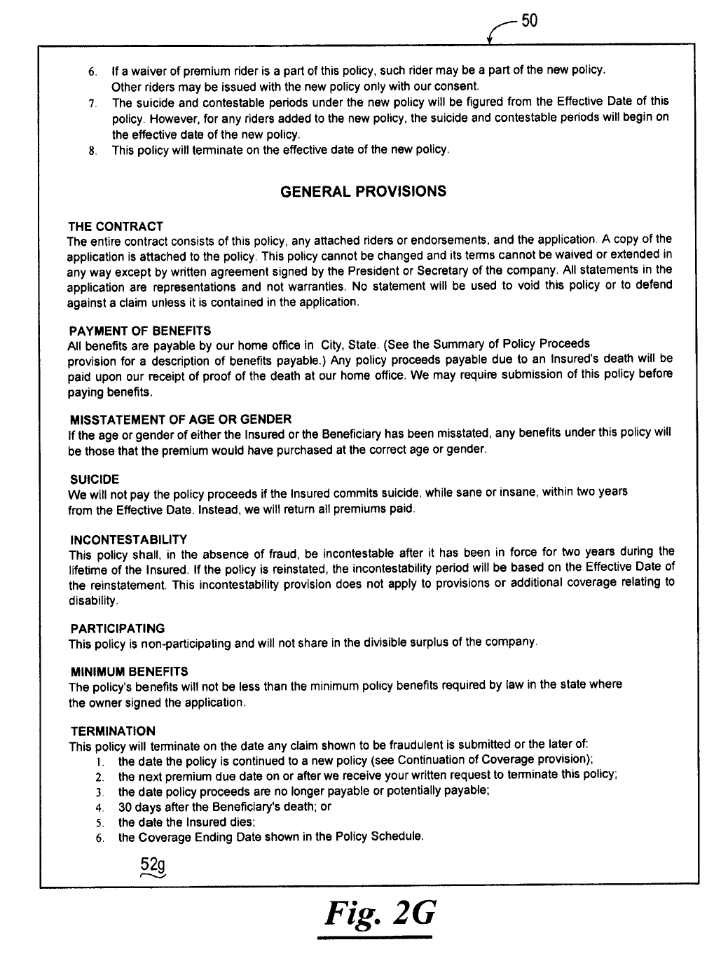

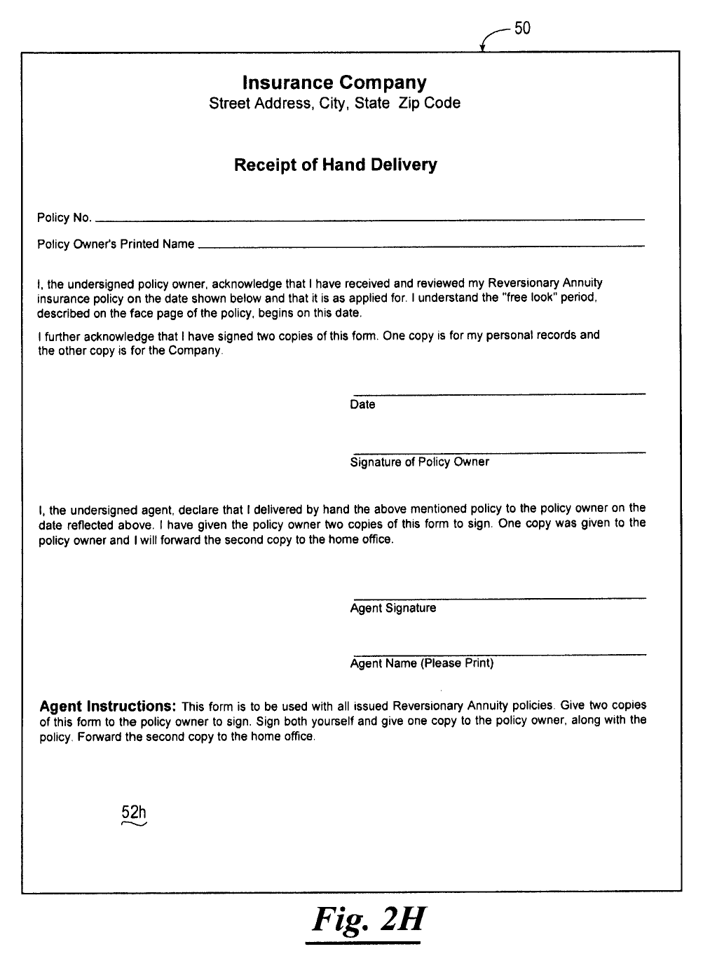

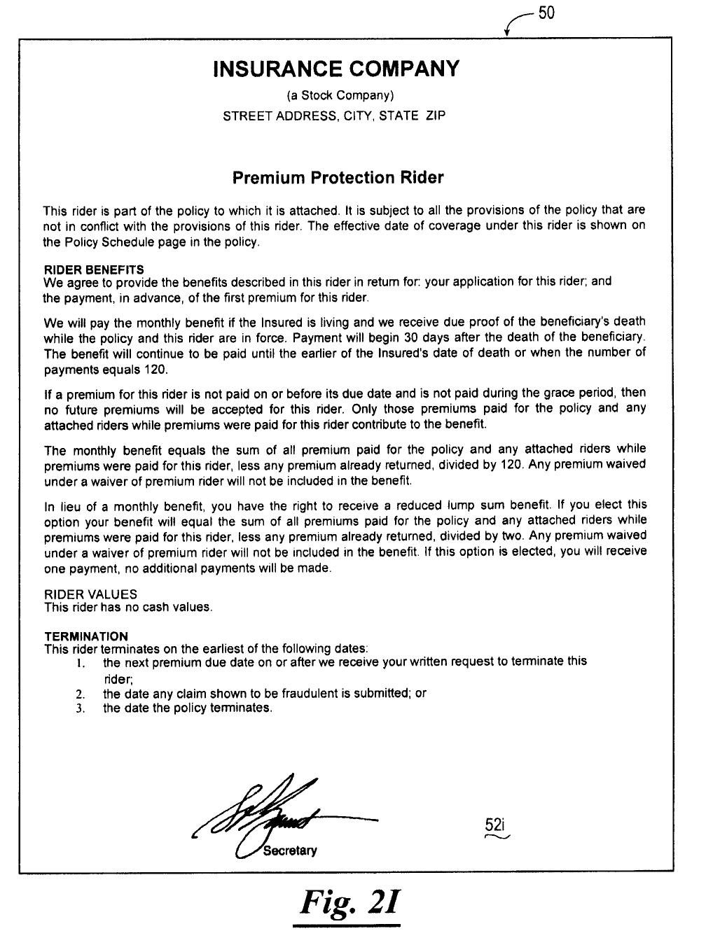

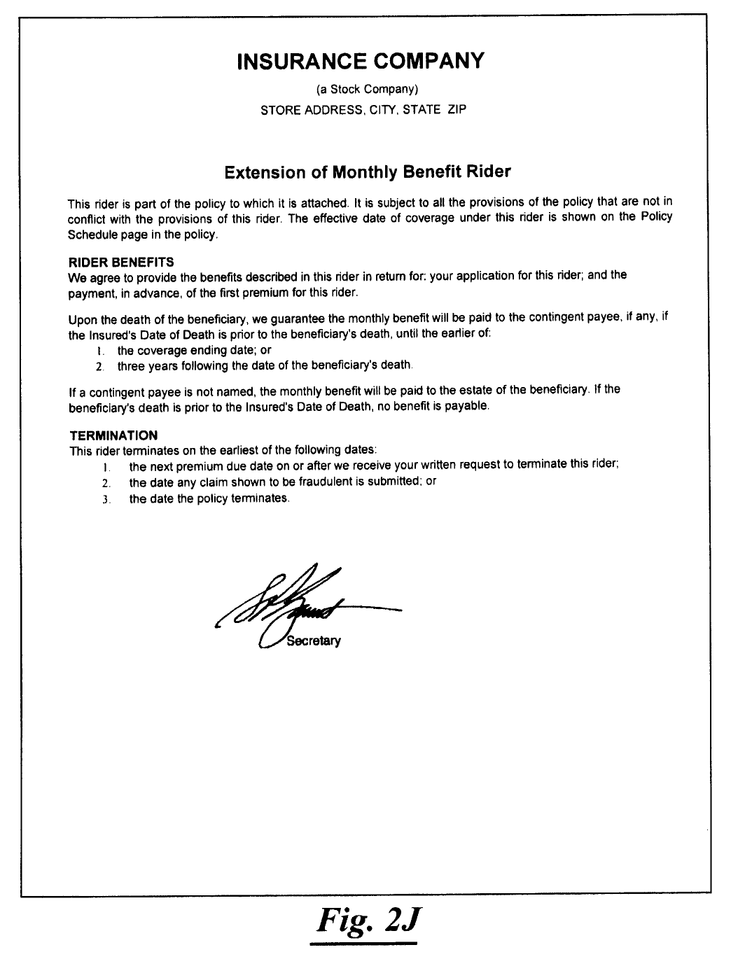

Once the initial premium and the maximum premium are accepted, then the method branches to a block 22 where an insurance product generated in accordance with the information obtained and agreed upon during steps 12-20 is executed between an insurance company and the owner of the insurance product. The insurance product can be executed in a variety of manners, such as a written agreement, an electronic agreement or the like such that the insurance company and the owner of the insurance product indicate and record acceptance of the agreement. An exemplary insurance product having John Doe as an insured and owner, and Jane Doe as a beneficiary is shown in FIGS. 2a-2j.

Once the insurance product is executed, then the insurance company tracks premium payments as indicated by blocks 24 and 26. If the premium payments lapse during the premium paying period, then the insurance product is terminated as indicated by a block 28. If the premium payments have not lapsed, then the insurance company (or its agent) optionally determines whether or not the beneficiary(ies) and the insured(s) are deceased as indicated by blocks 30, 32 and 34, and if so whether or not the insurance product should be terminated as per block 28, or whether death benefits are due as per blocks 34, 36 and 38.

If the payments have not lapsed, and the beneficiary(ies) and the insured(s) are still living, the method 10 then determines whether any of the premium factors have changed (per block 40) and if so whether a premium adjustment is allowed under the insurance product (per block 42), e.g., whether the maximum premium has been reached. If a premium adjustment is allowed, then the method 10 adjusts the premium per block 44 and then branches back to block 24 to track future premium payments. As discussed above and illustrated in block 16, the premium is determined based on the actuarial data and other risk factors. Thus the step represented in block 44 re-evaluates changes in the actuarial data and risk factors to determine an updated premium amount, the updated premium amount being limited by the maximum premium as determined at the time of issuance of the insurance product and set forth therein.

If the premium factors have not changed, or a premium adjustment is not allowed, then the method 10 leaves the premium unchanged and then branches back to block 42 to track future premium payments.

Referring now to FIGS. 2A-2J, shown therein is an exemplary term insurance product 50 constructed in accordance with the present invention. The insurance product 50 is provided with one or more mediums 52A-52J, which are shown by way of example as sheets of paper. The term “medium” as used herein is a device in which information can be embodied or fixed and from which the information embodied therein can be perceived, reproduced, used or otherwise communicated, either directly or with the aid of another machine or device such as a computer. For example, a piece of paper is a medium in which information, such as writing or printing can be embodied or fixed. By way of another example, a fixed or portable memory is a medium in which information in the form of programs or data and the information so embodied in the memory can be used with a machine or computer adapted to accept the memory and use the information embodied therein. Other examples of mediums include hard disk drives, distributed storage arrays, floppy or removable disks, CD-ROMs, DVDs or the like. Still other examples of mediums will be apparent to those skilled in the art in view of the foregoing definition when read in conjunction with the description of the invention contained herein.

The insurance product 50 further comprises indicia 54 recorded on the one or more mediums identifying one or more insured 54a (see FIG. 2B) and one or more beneficiary 54b (see FIG. 2B), a fixed (or permanent) term for the life insurance product 54c (see FIG. 2C), a payment schedule for premiums 54d (see FIG. 2C), a determined death benefit 54e (see FIG. 2B) payable to the beneficiary upon death of the insured where the death benefits are defined as a guaranteed stream of payments to be paid for at least a portion of the remaining life of the beneficiary. The indicia 54a-e can be recorded in any suitable form on the one or more mediums 52a-J and the form in which the indicia 54 is recorded will typically depend upon the type of medium. For example, if the one or more medium 52 is paper, then the indicia 54a-e will typically be recorded by printing or writing the indicia 54a-e onto the paper. However, if the one or more medium 52 is a memory, then the indicia 54a-e will typically be registered in a digital format into the memory.

The insurance product 50 is also provided with a means for executing the one or mediums to form a life insurance contract. In a preferred embodiment, the means is implemented as indicia 56 (see FIG. 2A) of one or more signature lines on a medium made of paper for signing and dating by the owner, insured or beneficiary with a writing instrument, such as a pen. However, it should be understood that the means for executing the one or more mediums can be implemented in other manners, such as electronically or optically. For example, the means for executing can be implemented as logic or instructions running on a computer system where the owner executes the contract with the use of an electronic signature pad, keyboard, mouse, or a check-box on a screen.

The insurance product 50 can be modified or varied in a number of manners. For example, the payment schedule can be in the form of an indeterminate premium capped by a maximum premium for the premium paying period. Further, the insurance product may also be provided with indicia 58 (See FIG. 2A) recorded on the one or more mediums 52 defining that no benefit will be paid if the beneficiary dies prior to the death of the insured.

In another example of the presently disclosed and claimed invention, the insurance product is provided with indicia recorded on the one or more mediums identifying an insured and a beneficiary, a fixed term for the life insurance product, a payment schedule for premiums, a determined death benefit payable to the beneficiary upon death of the insured where the death benefits are defined as a guaranteed stream of payments to be paid for the life of the beneficiary. In this example, the insurance product also includes means for executing the one or mediums to form a life insurance contract as described above.

This insurance product can also be varied in a number of manners. For example, the indicia of the payment schedule can be defined further as indicia of an indeterminate premium capped by a maximum premium for the premium make this consistent paying period. As another example, the insurance product can include indicia defining that no benefit will be paid if the beneficiary dies prior to the death of the insured.

The method 10 discussed above can be accomplished either manually or with the aid of a computer typically having an (1) an input device, such as a mouse, keyboard, touchscreen or digitizing tablet technology allowing a user to operate the computer with a stylus or digital pen, or a fingertip; (2) one or more output devices, such as a monitor and a printer. The computer preferably runs database software (or firmware) adapted to perform the functions described herein, as well as to produce the insurance products discussed herein which are preferably stored on one or more medium which may or may not be computer readable.

The term “Computer” as used herein means a system or systems that are able to embody and/or execute the logic of the processes described herein. The logic embodied in the form of software instructions or firmware may be executed on any appropriate hardware which may be a dedicated system or systems, or a general purpose computer system, a personal computer system or distributed processing computer system, all of which are well understood in the art, and a detailed description of how to make or use such computer systems is not deemed necessary herein. When the computer is used to execute the logic of the processes described herein, such computer(s) and/or execution can be conducted at a same geographic location or multiple different geographic locations. Furthermore, the execution of the logic can be conducted continuously or at multiple discrete times. Further, such logic can be performed about simultaneously with the collecting of the information from the insured, beneficiary and/or owner, or thereafter or combinations thereof.

Although the foregoing invention has been described in some detail by way of illustration and example for purposes of clarity of understanding, it will be obvious to those skilled in the art that certain changes and modifications may be practiced without departing from the spirit and scope thereof, as described in this specification and as defined in the appended claims below. The term “comprising” within the claims is intended to mean “including at least” such that the recited listing of elements in a claim are an open group. “A,” “an” and other singular terms are intended to include the plural forms thereof unless specifically excluded.

What is claimed is:

1. A term life insurance product, comprising:
one or more mediums;
indicia recorded on the one or more mediums identifying an insured and an irrevocable beneficiary;
indicia recorded on the one or more mediums identifying a fixed coverage term for the life insurance product and a payment schedule for premiums;
indicia recorded on the one or more mediums identifying a determined death benefit payable to the irrevocable beneficiary, the death benefit being initiated upon the death of the insured;
indicia recorded on the one or more mediums defining a payment term, wherein the death benefit is a guaranteed stream of payments to be paid to the irrevocable beneficiary during the payment term;
indicia recorded on the one or more mediums defining that no death benefit will be paid if the irrevocable beneficiary dies prior to the death of the insured; and
means for executing the one or mediums to form a life insurance contract.

2. The term life insurance product of claim 1, wherein the fixed coverage term is a number of years.

3. The term life insurance product of claim 1, wherein the fixed coverage term terminates upon the insured reaching a terminal age.

4. The term life insurance product of claim 1, wherein the indicia of the payment schedule is defined further as having a maximum premium.

5. The term life insurance product of claim 1, further comprising indicia recorded on the one or more mediums defining that the insurance product has no cash value.

6. A term life insurance product, comprising:
one or more mediums;
indicia recorded on the one or more mediums identifying a first insured and a second insured and a first irrevocable beneficiary and a second irrevocable beneficiary, wherein the first insured is the second irrevocable beneficiary and the second insured is the first irrevocable beneficiary;
indicia recorded on the one or more mediums identifying a fixed coverage term for the life insurance product and a payment schedule for premiums;
indicia recorded on the one or more mediums identifying a first determined death benefit payable to the first irrevocable beneficiary and a second determined death benefit payable to the second irrevocable beneficiary, the first death benefit being initiated upon the death of the first insured if the first irrevocable beneficiary does not predecease the first insured, the second death benefit being initiated upon the death of the second insured if the second irrevocable beneficiary does not predecease the second insured whereby only one of the first and second determined death benefits is payable;
indicia recorded on the one or more mediums defining a payment term, wherein the first and second death benefit is a guaranteed stream of payments to be paid to the first and second irrevocable beneficiary during the payment term; and
means for executing the one or mediums to form a life insurance contract.

7. The life insurance product of claim 6, wherein the fixed coverage term is a number of years.

8. The life insurance product of claim 6, wherein the fixed coverage term terminates upon the first or second insured reaching a terminal age.

9. The life insurance product of claim 6, wherein the indicia of the payment schedule is defined further as having a maximum premium.

10. The life insurance product of claim 6, further comprising indicia recorded on the one or more mediums defining that the insurance product has no cash value.

11. A life insurance product, comprising:
one or more mediums;
indicia recorded on the one or more mediums identifying an insured and an irrevocable beneficiary;
indicia recorded on the one or more mediums identifying a fixed coverage period for the life insurance product and a payment schedule for premiums;
indicia recorded on the one or more mediums identifying a determined death benefit payable to the irrevocable beneficiary, the death benefit being initiated upon the death of the insured;
indicia recorded on the one or more mediums defining a death benefit as a guaranteed stream of payments to be paid to the irrevocable beneficiary during the life of the beneficiary;
indicia recorded on the one or more mediums defining that no death benefit will be paid if the irrevocable beneficiary dies prior to the death of the insured; and
means for executing the one or mediums to form a life insurance contract.

12. The life insurance product of claim 11, wherein the fixed coverage period is the lifetime of the insured.

13. The life insurance product of claim 11, wherein the indicia of the payment schedule is defined further as having a maximum premium.

14. The life insurance product of claim 11, further comprising indicia recorded on the one or more mediums defining that the insurance product has no cash value.

15. A life insurance product, comprising:
one or more mediums;
indicia recorded on the one or more mediums identifying a first insured and a second insured and a first irrevocable beneficiary and a second irrevocable beneficiary, wherein the first insured is the second irrevocable beneficiary and the second insured is the first irrevocable beneficiary;
indicia recorded on the one or more mediums identifying a fixed coverage period for the life insurance product and a payment schedule for premiums;
indicia recorded on the one or more mediums identifying a first determined death benefit payable to the first irrevocable beneficiary and a second determined death benefit payable to the second irrevocable beneficiary, the first death benefit being initiated upon the death of the first insured if the first irrevocable beneficiary has not predeceased the first insured, the second death benefit being initiated upon the death of the second insured if the second irrevocable beneficiary has not predeceased the second insured;
indicia recorded on the one or more mediums defining the first determined death benefit as a guaranteed stream of payments to be paid to the first irrevocable beneficiary during the life of the first irrevocable beneficiary;
indicia recorded on the one or more mediums defining a second determined death benefit as a guaranteed stream of payments to be paid to the second irrevocable beneficiary during the life if the second irrevocable beneficiary; and
means for executing the one or mediums to form a life insurance contract.

16. The life insurance product of claim 1, wherein the fixed coverage term is a number of years.

17. The life insurance product of claim 1, wherein the fixed coverage term terminates upon the first or second insured reaching a terminal age.

18. The life insurance product of claim 1, wherein the indicia of the payment schedule is defined further as having a maximum premium.

19. The life insurance product of claim 1, further comprising indicia recorded on the one or more mediums defining that the insurance product has a cash value.

20. A method for generating a life insurance product, comprising:
selecting a medium;
identifying an owner, an insured, and an irrevocable beneficiary;
collecting actuarial data and risk factors for the insured and beneficiary;
selecting a death benefit;
analyzing the actuarial data and risk factors for the insured to determine a premium;
presenting the death benefit and premium to the owner for acceptance; and
generating a term reversionary annuity insurance product on the medium in response to acceptance by the owner to form a life insurance contract.

21. The method of claim 20 wherein the life insurance product is a term life insurance product.

22. The method of claim 20 wherein the life insurance product is a permanent life insurance product.

23. The method of claim 20, wherein the premium payments are adjustable in response to changes in the actuarial data and risk factors of the insured but are limited to a maximum premium payment.
